(19) United States
(12) Patent Application Publication
(10) Pub. No.: US 2005/0086667 A1
(43) Pub. Date: Apr. 21, 2005

(54) Symmetric Scheduling for parallel execution

(76) Inventors: Feng Jin, Shanghai (CN); Xiang Ma, Shanghai (CN); Shaofan Li, Shanghai (CN); Lechong Chen, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/676,481

(22) Filed: Sep. 30, 2003

(51) Int. Cl. G06F 13/00; G06F 3/00; G06F 9/44; G06F 9/46; G06F 7/00; G06F 17/00

(52) U.S. Cl. 719/327; 707/100

(57) ABSTRACT

According to an embodiment of the invention, a method and apparatus for symmetric scheduling for parallel execution is described. An embodiment of a method comprises building a queue having one or more drivers; and executing the one or more drivers in the queue using a plurality of processors, wherein the execution of drivers by each of the plurality of processors includes determining whether there is a driver in the queue, determining whether the driver is ready for execution, and if the driver is ready for execution, executing the driver.

### FIELD

An embodiment of the invention relates to computer operation in general, and more specifically to symmetric scheduling for parallel execution.

### BACKGROUND

In computer operations, system initiation may include the execution of certain drivers prior to booting the operating system. The drivers may include EFI (Extensible Firmware Interface) drivers. Driver execution may be a time consuming process for a computer system.

Multiple logical or physical processors may be available for certain computer operations. However, conventional scheduling of drivers for execution may not make sufficient use of available capabilities of the computer architecture in system initialization. Scheduling for driver execution for multiple drivers may create complications. The drivers may have dependencies that require that the execution of the drivers be performed in a certain order, complicating the scheduling process. Further, driver scheduling may involve high levels of overhead costs for a system. Multi-threading and multi-tasking in a conventional operating environment have not generally been available in the pre-boot space, due at least in part to high cost of task scheduling.

### BRIEF DESCRIPTION OF THE DRAWINGS

The invention may be best understood by referring to the following description and accompanying drawings that are used to illustrate embodiments of the invention. In the drawings:

FIG. 1 illustrates an embodiment of a multiple processor system;

FIG. 2 illustrates an embodiment of system initialization;

FIG. 3 is a flow chart for an embodiment of a driver dispatching loop;

FIG. 4 illustrates dependency of exemplary drivers for an embodiment of the invention;

FIG. 5 illustrates timing for system initiation without parallel scheduling;

FIG. 6 illustrates timing for an embodiment of system initiation utilizing symmetric scheduling; and

FIG. 7 illustrates an embodiment of a computer environment.

### DETAILED DESCRIPTION

A method and apparatus are described for symmetric scheduling for parallel execution.

Before describing an exemplary environment in which various embodiments of the present invention may be implemented, certain terms that will be used in this application will be briefly defined:

As used herein, “bootstrap processor” means a processor to initialize a system. Initialization of a system may include booting an operating system.

As used herein, “application processor” means a processor other than a bootstrap processor to execute applications and processes in a system.

Under an embodiment of the invention, symmetric scheduling is provided for parallel execution. The scheduling includes scheduling of drivers for execution, including EFI (extensible firmware interface) drivers. EFI describes an interface between an operating system (OS) and platform firmware. The interface is described more fully in the specification, Extensible Firmware Interface Specification, version 1.10, Dec. 1, 2002, Intel Corporation.

An embodiment of the invention may be implemented in various environments, including a multi-processor (MP) or hyper-threading (HT) enabled platform. Under a particular embodiment of the invention, an algorithm is utilized to provide scheduling to leverage multi-processor or hyper-threading central processing unit (CPU) architecture and allow efficient simultaneous execution of drivers.

Under an embodiment of the invention, a symmetric scheduling algorithm is provided that doesn't differentiate between a bootstrap processor (BSP) and other processors in dispatching EFI drivers in parallel, thereby allowing efficient parallel operations. Multiple processors perform the same role with regard to executing drivers in the dispatching process, thereby taking advantage of the computing resources of the underlying computer infrastructure for initiation processes.

The symmetric dispatch of drivers may include the operation of both a bootstrap processor that is responsible for the initiation of the system and other system processors, which may be referred to herein as application processors (APs). An embodiment of the invention provides a practicable symmetric scheduling algorithm for parallel execution on a system, such as a multi-processor or hyper-threading system, by utilizing of application processors to dispatch EFI drivers without differentiating between the bootstrap processor and the application processors for the dispatch process. The scheduling algorithm may thus provide a high level of parallelism on a multi-processor or hyper-threading system.

Under an embodiment of the invention, an algorithm enables drivers to be executed in parallel to reduce boot time by utilizing both the bootstrap processors and application processors for dispatch operation. The algorithm treats each driver as an atom (as a single unit or statement) and does not switch away during execution of the driver. Prevention of any process of switching away during execution of a driver may help reduce processing overhead costs.

Under an embodiment of the invention, multiple processors responsible for dispatch of drivers may be separate physical processors or may be separate logical processors. In hyper-threading operation, a physical processor may include multiple logical processors. Hyper-threading operates by duplicating certain portions of a processor, without duplicating the main execution resources. A physical processor can thus execute multiple pieces of software code (multiple threads or processes) in parallel. Under an embodiment of the invention, multiple logical processors included in a physical processor are utilized to execute drivers in parallel.

There are generally two phases of platform initialization in EFI-based BIOS (basic input output system):
(1) Pre-EFI Initialization (PEI); and
(2) Driver Execution Environment (DXE).
   According to an embodiment of the invention, a bootstrap processor is selected to provide initialization, including running PEI and DXE core initialization for EFI-based BIOS. The PEI phase is responsible for initializing the minimum system resources for enablement of the DXE phase. In the DXE phase various drivers are executed collectively to initialize the platform into the final pre-boot state. The DXE core is responsible for discovering the drivers and executing the drivers in a correct order. The DXE thus may be considered to be a driver dispatcher.

Under an embodiment of the invention, during DXE core initialization, at least two tasks are accomplished. A first task is to initialize application processors so as to make the application processors available at the very beginning of the DXE phase. A second task is to detect drivers and build a discovered driver queue. After DXE core initialization, each processor, including the bootstrap processor and each application processor, attempts to identify a driver ready for execution from the discovered driver queue. Once such a driver is identified, the processor executes the driver. After the execution of the driver, the processor returns to the discovered driver queue to attempt to obtain another driver ready for execution. The process continues until all the drivers are dispatched from the discovered driver queue, and the dispatching process is completed. At this point, the bootstrap processor is ready to boot the operating system (OS).

Dependencies may exist between the drivers thereby affecting the order of execution. A driver generally is not executed until its dependencies have been satisfied. Whether a driver is ready for execution may be determined by evaluating the dependencies of the driver. At any time in an initiation process there may be multiple drivers that ready for execution that do not share any dependencies. Because there are no dependencies between these drivers, an embodiment of a scheduling algorithm may provide for execution of the ready drivers wholly or partially in parallel.

In an embodiment of the invention in which multiple processors are accessing a discovered driver queue, the concurrent accesses by the processors to the queue may require synchronization. Synchronization mechanisms for multiple processor operation are commonly understood by those of ordinary skill in the art and thus are not discussed in depth in this disclosure.

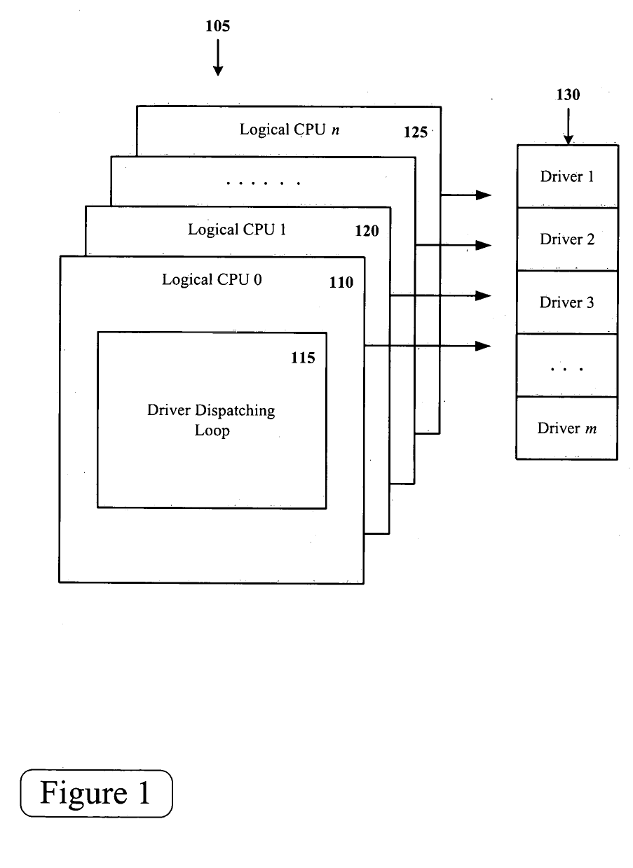

FIG. 1 illustrates an embodiment of a multiple processor system. In this illustration, a plurality of logical processors operate in parallel to dispatch drivers. For example, Logical CPU 0 110, Logical CPU 1 120, through Logical CPU n 125 operate in parallel in the dispatch of drivers. The drivers to be dispatched are collected in a queue 130 and are shown as Driver 1 through Driver m.

Each of the logical processors shown in FIG. 1 access the queue 130 to determine whether there are any drivers left to be dispatched and, if so, to obtain the next driver for dispatch. Each logical processor utilizes a driver dispatching loop 115 for the purpose of dispatching the drivers in the queue.

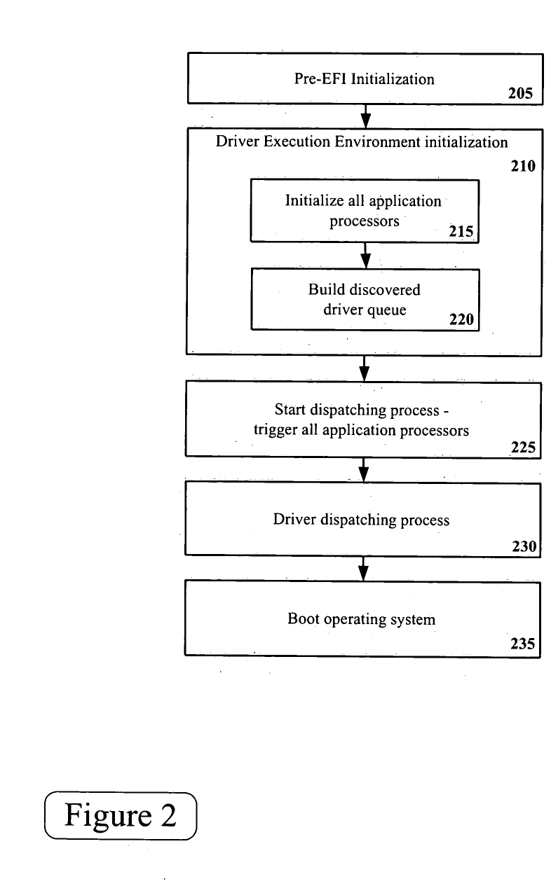

FIG. 2 illustrates an embodiment of the initialization of a system. In this illustration, multiple logical processors, including a bootstrap processor and one or more application processors, are available. The following processes may be included in system initialization by the bootstrap processor:
(1) Run PEI 205.
(2) Perform DXE core initialization 210. Initialization includes initializing other logical CPUs (the application processors) 215, and building the discovered driver queue 220.
(3) Start the driver dispatching process. In the dispatching process, trigger all application processors to run the driver dispatching loop 225. The bootstrap processor also starts to run the same driver dispatching loop, as shown in processes (4) through (10) below.

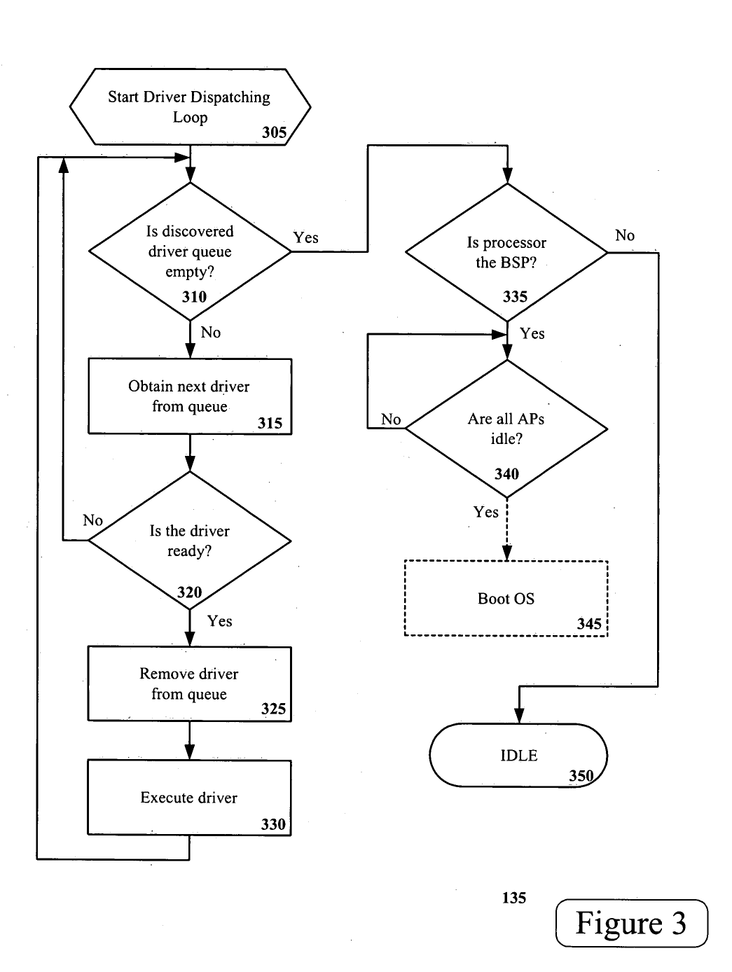

An embodiment of a driver dispatching loop 305 is illustrated in FIG. 3. In this illustration, process (10) applies only to the bootstrap processor. Processes (4)-(9) apply to both the bootstrap processor and any application processor. A driver dispatching loop may comprise the following processes:
(4) Determine whether the discovered driver queue is empty 310.
(5) If the queue is empty and thus all drivers have been dispatched:
a. Check the type of the logical CPU 335.
b. If the logical CPU is not the bootstrap processor, go to idle status 350.
c. If the logical processor is the bootstrap processor, determine whether all application processors are idle 340 to ensure that all the drivers have been executed completely. When all application processors are idle, go to process (10).
(6) If the queue is not empty, obtain the next driver from the discovered driver queue 315.
(7) Determine if the driver is ready to be executed by evaluating the driver's dependencies 320. If the driver is not ready for execution, return to process (4).
(8) Remove the driver from the discovered driver queue 325.
(9) Execute the driver 330. After execution, return to process (4).
(10) With all drivers now dispatched, boot the operating system 345.

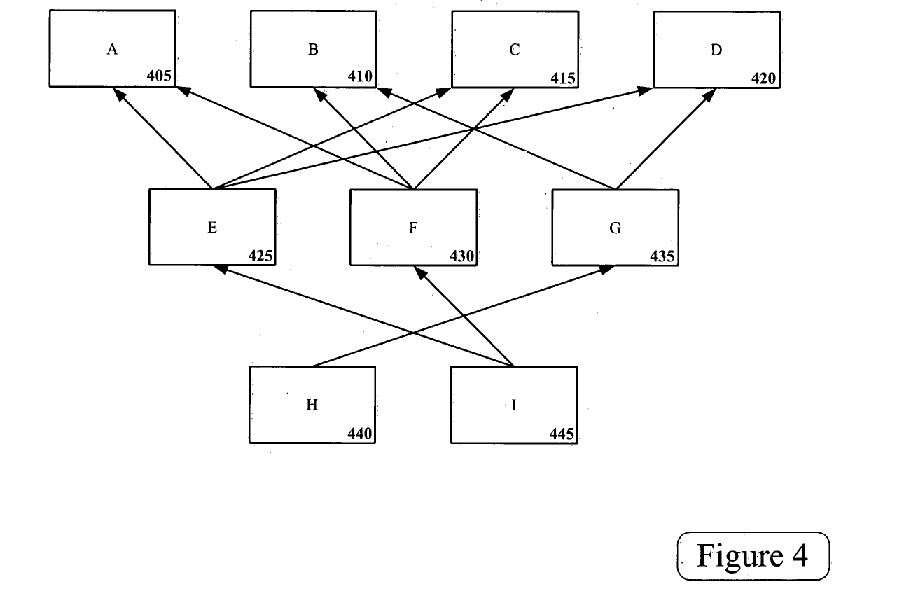

FIG. 4 illustrates dependencies in drivers for an embodiment of the invention. The drivers are shown as Driver A 405 through Driver 1445. In this illustration, Driver A 405, Driver B 410, Driver C 415, and Driver D 420 have no dependencies to be satisfied prior to execution and thus these drivers can be executed in parallel. Driver E 425 has dependencies on Driver A 405, Driver C 415, and Driver D 420 and thus these drivers are executed before Driver E 425 is executed. Similarly, Driver F 430 has dependencies on Driver A 405, Driver B 410, and Driver C 415; Driver G has dependencies on Driver B 410 and Driver D 420; Driver H has a dependency on Driver G 435; and Driver I has dependencies on Driver E 425 and Driver F 430.

The dependencies shown in FIG. 4 comprise one example that is provided for illustration. An embodiment of the invention may be utilized with any number of drivers and any kind of dependency relationship between the drivers.

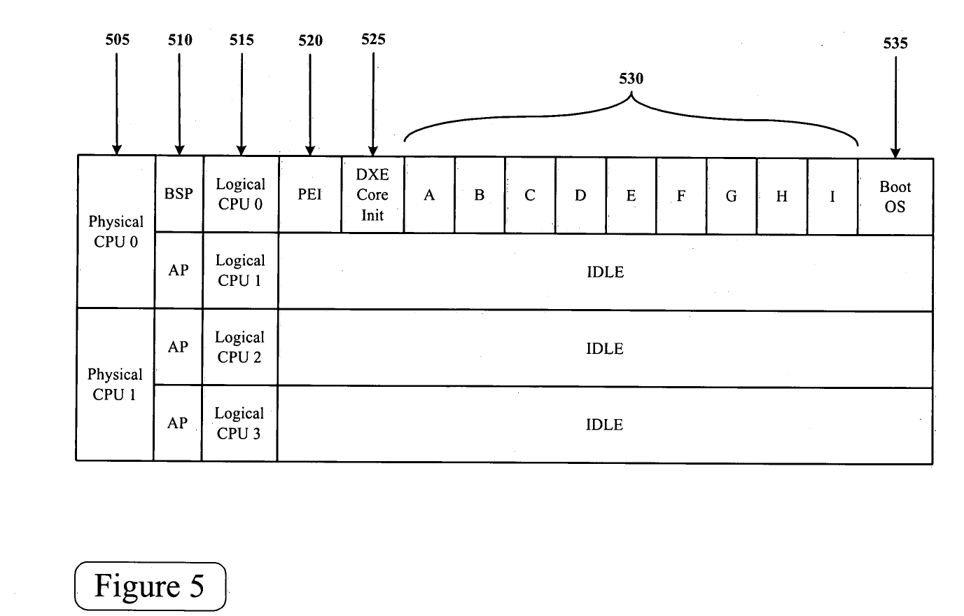

FIG. 5 illustrates the initialization of a system that includes the drivers and dependencies shown in FIG. 4. In this illustration, all drivers are dispatched by a bootstrap processor. The system that is illustrated includes two physical processors, Physical CPU 0 and Physical CPU 1 505. Physical CPU 0 includes Logical CPU 0, which is a bootstrap processor, and Logical CPU 1, an application processor, 510 and 515. Physical CPU 1 includes Logical CPU 2, and Logical CPU 3, which are application processors, 510 and 515.

In the illustration shown in FIG. 5, the initialization of a system includes a Pre-EFI Initialization 520 and a Driver Execution Environment core initialization 525 by the bootstrap processor. Following such phases, the bootstrap processor dispatches the drivers in order 530. The bootstrap processor then boots the operating system 535. During the initialization processes, the application processors remain in an idle state 520 through 535.

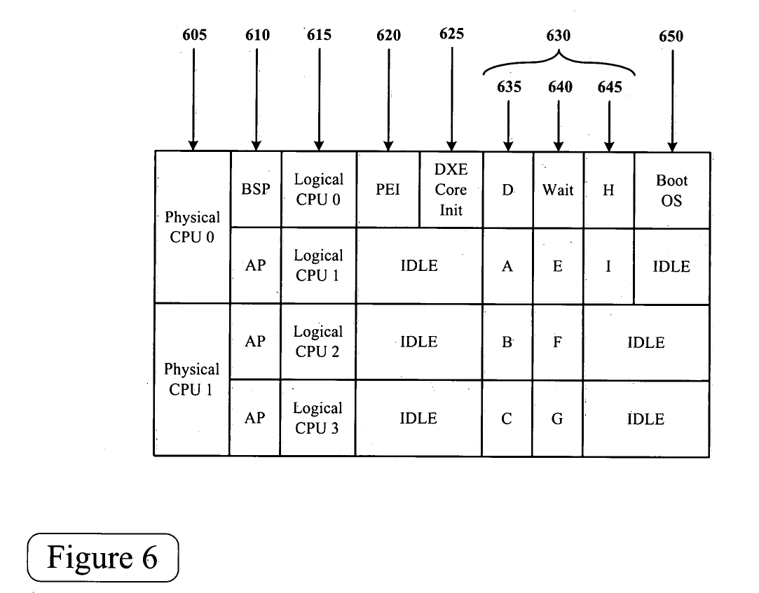

FIG. 6 illustrates an embodiment of the invention in which a system that includes the drivers and dependencies shown in FIG. 4 is initialized. In the illustrated embodiment, the drivers are scheduled for dispatch by a bootstrap processor and a plurality of application processors operating in parallel. The system illustrated -includes two physical processors, Physical CPU 0 and Physical CPU 1 605. Physical CPU 0 includes Logical CPU 0, a bootstrap processor, and Logical CPU 1, an application processor, 610 and 615. Physical CPU 1 includes Logical CPU 2, and Logical CPU 3, which are application processors, 610 and 615. All processors use the same process for purposes of driver execution.

In the illustration shown in FIG. 6, the initialization of a system includes a Pre-EFI Initialization 620 and a Driver Execution Environment core initialization 625 by the bootstrap processor. The application processors are in an idle state during such phases, 620 and 625. Following such phases, the bootstrap processor and the application processors dispatch the drivers in order 630.

In a first time period 635, each of the logical processors accesses a driver queue. Drivers A, B, C, and D are dispatched. As shown in FIG. 4, these drivers do not have any dependencies to be satisfied prior to dispatch and thus can be executed in parallel. Each driver is treated as an atom and processing of the drivers is completed without switching to any other operation.

After completing execution of a driver, each logical processor again accesses the queue to obtain another driver for dispatch. In a second time period 640, Drivers E, F, and G are dispatched. One of the processors (in this example, the bootstrap processor) has a Wait period because the remaining drivers have dependencies that have not been satisfied.

After dispatch of the drivers, each of the processors again accesses the queue to obtain another driver. Logical CPU 0 obtains driver H and logical CPU 1 obtains driver I. In a third time period 645, Drivers H and I are dispatched. Two of the processors, logical CPU 2 and logical CPU 3, access the queue and determine that there are no additional drivers to dispatch. As shown in the illustration, Logical CPU 2 and Logical CPU 3 then enter an idle state.

After dispatch of the drivers, logical CPU 0 and logical CPU 1 access the queue to obtain new drivers for dispatch. Upon determining that there are no additional drivers for dispatch, logical CPU 1 will enter an idle state. Logical CPU 0 will also determine that no additional drivers are available for dispatch. As the bootstrap processor, Logical CPU 0 will then determine whether all other processors are idle. Upon determining that all other processors are idle and thus that the dispatch of all drivers has been completed, the bootstrap processor will boot the operating system 650.

The illustration shown in FIG. 6 provides one example of operations for an embodiment of the invention. An embodiment of the invention may be implemented with any combination of processors and any combination of drivers, with the drivers having any combination of dependencies. For simplicity, FIG. 6 assumes that each driver is dispatched in approximately the same amount of time by each logical processor. In practice, the dispatch time may vary and thus the overlap of driver dispatch operations could vary. Synchronization of the processors in operation may be required to allow all processors to access the queue.

In the illustration shown in FIG. 6, the dispatch of drivers may be completed in a shorter time period than in a system in which all drivers are dispatched by the bootstrap processor, as illustrated in FIG. 5, because of the parallel operations that may be implemented. In the example provided in FIG. 6, the drivers are dispatched in three time periods, rather than in nine time periods as shown in FIG. 5 without parallel operation. However, the actual result in operation will vary depending on certain factors, including the dependencies of the individual drivers.

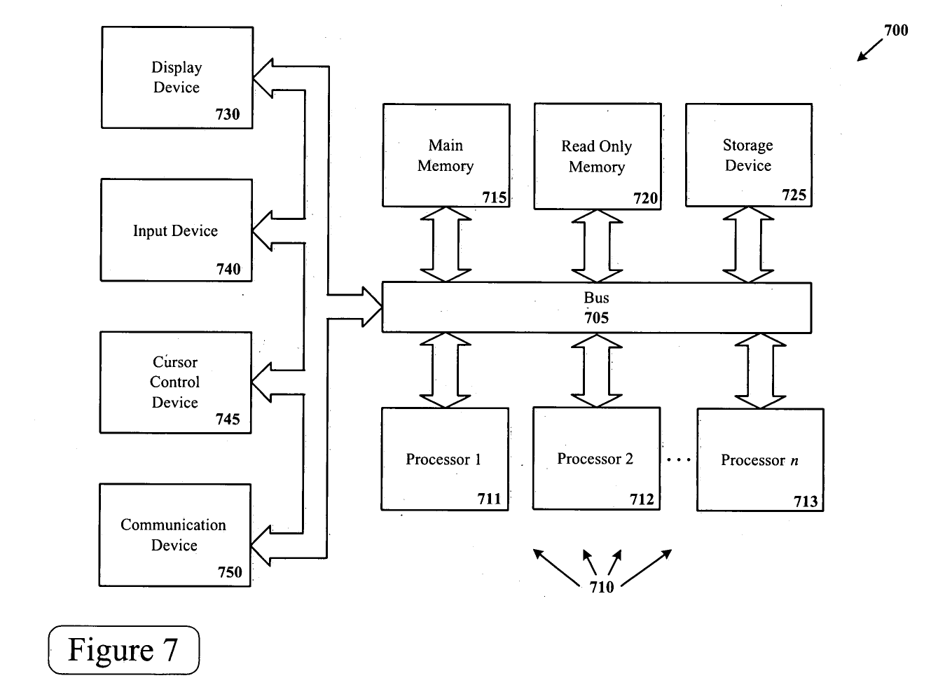

Techniques described here may be used in many different environments. FIG. 7 is block diagram of an embodiment of an exemplary computer. Under an embodiment of the invention, a computer 700 comprises a bus 705 or other communication means for communicating information, and a processing means such as one or more physical processors 710 (shown as 711, 712 and continuing through 713) coupled with the first bus 705 for processing information. Each of the physical processors may include multiple logical processors, and the logical processors may operate in parallel in the execution of drivers. Each processor may include an execution unit and logic for the operation of certain functions.

The computer 700 further comprises a random access memory (RAM) or other dynamic storage device as a main memory 715 for storing information and instructions to be executed by the processors 710. Main memory 715 also may be used for storing temporary variables or other intermediate information during execution of instructions by the processors 710. The computer 700 also may comprise a read only memory (ROM) 720 and/or other static storage device for storing static information and instructions for the processor 710.

A data storage device 725 may also be coupled to the bus 705 of the computer 700 for storing information and instructions. The data storage device 725 may include a magnetic disk or optical disc and its corresponding drive, flash memory or other nonvolatile memory, or other memory device. Such elements may be combined together or may be separate components, and utilize parts of other elements of the computer 700.

The computer 700 may also be coupled via the bus 705 to a display device 730, such as a liquid crystal display (LCD) or other display technology, for displaying information to an end user. In some environments, the display device may be a touch-screen that is also utilized as at least a part of an input device. In some environments, display device 730 may be or may include an auditory device, such as a speaker for providing auditory information. An input device 740 may be coupled to the bus 705 for communicating information and/or command selections to the processor 710. In various implementations, input device 740 may be a keyboard, a keypad, a touch-screen and stylus, a voice-activated system, or other input device, or combinations of such devices. Another type of user input device that may be included is a cursor control device 745, such as a mouse, a trackball, or cursor direction keys for communicating direction information and command selections to processor 710 and for controlling cursor movement on display device 730.

A communication device 750 may also be coupled to the bus 705. Depending upon the particular implementation, the communication device 750 may include a transceiver, a wireless modem, a network interface card, or other interface device. The computer 700 may be linked to a network or to other devices using the communication device 750, which may include links to the Internet, a local area network, or another environment.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamliriing the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A method comprising:
building a queue having one or more drivers; and
executing the one or more drivers in the queue using a plurality of processors, wherein the execution of drivers by each of the plurality of processors includes:
determining whether there is a driver in the queue,
determining whether the driver is ready for execution, and
if the driver is ready for execution, executing the driver.

2. The method of claim 1, wherein a first processor of the plurality of processors is a bootstrap processor.

3. The method of claim 2, wherein the plurality of processors includes one or more application processors.

4. The method of claim 2, wherein if a second processor in the plurality of processors determines that there are no drivers left in the queue, the second processor goes to an idle state.

5. The method of claim 4, wherein if the first processor determines there are no drivers left in the queue, the first processor:
waits until all other processors in the plurality of processors are in an idle state; and
boots an operating system.

6. The method of claim 1, wherein the plurality of processors includes one or more logical processors.

7. The method of claim 1, wherein the execution of drivers in the queue further comprises removing a driver from the queue if the driver is ready for execution.

8. The method of claim 1, wherein the method is utilized in an extensible firmware interface (EFI).

9. The method of claim 1, wherein the plurality of drivers are executed in order.

10. The method of claim 9, wherein a first driver in the queue that has a dependency on a second driver in the queue is not executed until the second driver has been executed.

11. A processor comprising:
an execution unit; and
a first logical processor and a second logical processor, the first logical processor and the second logical processor utilizing the execution unit;
the first logical processor to build a queue having one or more drivers; and
the first logical processor and the second logical processor to execute the one or more drivers in the queue in parallel at least in part, wherein the execution of drivers includes:
determining whether there is a driver in the queue,
determining whether the driver is ready for execution, and
if the driver is ready for execution, executing the driver.

12. The processor of claim 11, wherein if the second logical processor determines there are no drivers left in the queue, the second logical processor is to enter an idle state.

13. The processor of claim 12, wherein if the first logical processor determines there are no drivers left in the queue, the first logical processor is to:
wait until the second processor is in an idle state; and
boot an operating system.

14. The processor of claim 11, wherein the processor operates concurrently with one or more other processors.

15. The processor of claim 11, wherein the execution of drivers in the queue further comprises removing the driver from the queue if the driver is ready for execution.

16. A system comprising:
a bootstrap processor;
one or more application processors;
a bus, the bootstrap processor and the one or more application processors being coupled to the bus; and
a flash memory coupled to the bus;
wherein the bootstrap processor and the one or more application processors execute a plurality of drivers in parallel at least in part, the execution of the drivers by the bootstrap processor and each of the one or more application processors including:
determining whether there is a driver to be executed,
determining whether the driver is ready for execution, and
if the driver is ready for execution, executing the driver.

17. The system of claim 16, wherein if an application processor determines that there are no drivers left in the queue, the application processor is to enter an idle state.

18. The system of claim 17, if the first processor determines there are no drivers left in the queue, the first processor is to:
wait until all of the one or more application processors are in an idle state; and
boot an operating system.

19. The system of claim 16, the execution of drivers in the queue further comprises removing a driver from the queue if the driver is ready for execution.

20. The system of claim 19, the method is utilized in an extensible firmware interface (EFI).

21. A machine-readable medium having stored thereon data representing sequences of instructions that, when executed by a processor, cause the processor to perform operations comprising:
building a queue having one or more drivers; and
executing the one or more drivers in the queue using a plurality of processors, wherein the execution of drivers by each of the plurality of processors includes:
determining whether there is a driver in the queue,
determining whether the driver is ready for execution, and
if the driver is ready for execution, executing the driver.

22. The medium of claim 21, wherein a first processor of the plurality of processors is a bootstrap processor.

23. The medium of claim 22, wherein the plurality of processors includes one or more application processors.

24. The medium of claim 22, wherein if a second processor of the plurality of processors determines that there are no drivers left in the queue, the second processor goes to an idle state.

25. The medium of claim 24, wherein if the first processor determines there are no drivers left in the queue, the first processor is to:
wait until all other processors in the plurality of processors are in an idle state; and
boot an operating system.

26. The medium of claim 21, wherein the plurality of processors includes one or more logical processors.

27. The medium of claim 21, wherein the execution of drivers in the queue further comprises removing a driver from the queue if the driver is ready for execution.

28. The medium of claim 21, wherein the method is utilized in an extensible firmware interface (EFI).

29. The medium of claim 21, wherein the plurality of drivers are executed in order.

30. The medium of claim 29, wherein a first driver in the queue that has a dependency on a second driver in the queue is not executed until the second driver has been executed.
